(19) United States
(12) Patent Application Publication
(10) Pub. No.: US 2021/0251145 A1
(43) Pub. Date: Aug. 19, 2021

(54) Swiveling Wedge for Distribution of Picked Fruit

(71) Applicant: Abundant Robotics, Inc., Hayward, CA (US)

(72) Inventors: Stephen Nuske, Hayward, CA (US); Curt Salisbury, San Ramon, CA (US)

(21) Appl. No.: 17/251,842

(22) PCT Filed: Aug. 20, 2019
(86) PCT No.: PCT/US2019/047150

§ 371 Date: Dec. 14, 2020

Related U.S. Application Data
(60) Provisional application No. 62/725,986, filed on Aug. 31, 2018.

(51) Int. Cl. A01D 46/00; A01D 46/30; A01D 46/24

(52) U.S. Cl. CPC A01D 46/005; A01D 46/24; A01D 46/30

(57) ABSTRACT

An example harvesting device includes: a conduit having a distal end and a proximal end; a nozzle coupled to the distal end of the conduit, wherein a vacuum generating device is configured to generate a vacuum environment in the conduit and the nozzle coupled thereto; a housing coupled to the proximal end of the conduit, wherein the housing defines a chamber therein, and wherein the housing includes a divider that partitions a portion of the chamber into a first section and a second section; and a wedge rotatably mounted within the housing, wherein: (i) when the wedge is in a first position, fruit that has traversed through the conduit is deflected to the first section, and (ii) when the wedge is in a second position, fruit that has traversed through the conduit is deflected to the second section.

### CROSS-REFERENCE TO RELATED APPLICATION

This application claims priority to U.S. Provisional Patent Application No. 62/725,986 filed Aug. 31, 2018, which is incorporated herein by reference in its entirety.

### BACKGROUND

Fruit plucking and harvesting remains a largely manual process. In a fruit orchard in which fruit such as apples, pears, apricots, peaches, etc., grows on trees, a farm laborer may move a ladder near a tree, climb the ladder, pluck the fruit, and transfer the fruit to a temporary storage like a basket. After the worker has plucked all the ripe fruit in that location, the worker climbs down and moves the ladder to another location, then repeats the process. This process has high labor requirements, which result in high costs of operation, thus lowering profits made by the farmers.

Relying on manual labor may also have other risks. For instance, illness or other unavailability of workers may affect the labor supply. As another example, the lack of untrained workers can lead to careless handling or mishandling of the fruit. While picking fruit seems to require workers of low skill and training, a skilled farm worker may pluck as many as two fruits per second with relatively low losses due to damage, whereas untrained workers may work significantly slower, and may cause much higher losses due to damaged fruit. The cost of training workers may contribute to significant cost increases in operating the farm.

Therefore, it may be desirable to have mechanized fruit harvesting systems that alleviate some of the risks associated with manual labor. An example mechanized system may have a robotic device with an end-effector configured to pluck a fruit rather than plucking the fruit manually. Further, some orchards may be allowed to grow clusters of fruit having two or three fruit growing from a single spur. It may be desirable to have an end-effector that is capable of plucking such clusters without damaging or bruising fruit during plucking or transfer of fruit.

### SUMMARY

The present disclosure describes embodiments that relate to a swiveling wedge for distribution of picked fruit.

In a first example implementation, the present disclosure describes a harvesting device. The harvesting device includes: a conduit having a distal end and a proximal end; a nozzle having an inlet, wherein the nozzle is coupled to the distal end of the conduit, wherein a vacuum generating device is configured to generate a vacuum environment in the conduit and the nozzle coupled thereto, and wherein the inlet of the nozzle has a size that allows fruit of a particular type to pass through the inlet and enter the vacuum environment in the nozzle; a housing coupled to the proximal end of the conduit, wherein the housing defines a chamber therein, and wherein the housing includes a divider that partitions a portion of the chamber into a first section and a second section; and a wedge rotatably mounted within the housing, wherein the wedge has an angled surface that faces the proximal end of the conduit, wherein the wedge is configured to be rotatable between a first position and a second position, and wherein: (i) when the wedge is in the first position, fruit that has traversed through the conduit is deflected to the first section, and (ii) when the wedge is in the second position, fruit that has traversed through the conduit is deflected to the second section.

In a second example implementation, the present disclosure describes a harvesting system. The harvesting system includes a harvesting device having: a conduit having a distal end and a proximal end; a nozzle coupled to the distal end of the conduit, wherein a vacuum generating device is configured to generate a vacuum environment in the conduit and the nozzle coupled thereto to pull fruit to within the nozzle and cause fruit to traverse the conduit; a housing coupled to the proximal end of the conduit, wherein the housing defines a chamber therein, and wherein the housing includes a divider that partitions a portion of the chamber into a first section and a second section; and a wedge rotatably mounted within the housing, wherein the wedge has an angled surface that faces the proximal end of the conduit. The harvesting system also includes an actuator coupled to the wedge and configured to rotate the wedge about a longitudinal axis of the conduit between a first position and a second position. When the wedge is in the first position, fruit that has traversed through the conduit is deflected to the first section, and when the wedge is in the second position, fruit that has traversed through the conduit is deflected to the second section. The harvesting system further includes a controller configured to perform operations comprising: detecting impact of fruit with the wedge, and responsively, causing the actuator to rotate the wedge.

In a third example implementation, the present disclosure describes a method. The method includes positioning a harvesting device within a predetermined distance from a fruit cluster having a first fruit and a second fruit. The harvesting device has a conduit, a nozzle coupled to a distal end of the conduit, and a deceleration structure coupled to a proximal end of the conduit, wherein a vacuum generating device is configured to generate a vacuum environment within the conduit and the nozzle, wherein the deceleration structure comprises a housing having a chamber therein and a wedge rotatably mounted within the housing and rotatable between a first position and a second position, wherein the wedge comprises an angled surface facing the proximal end of the conduit, wherein the chamber includes a divider that divides a portion of the chamber into a first section and a second section, and wherein the vacuum environment applies a force on the first fruit of the fruit cluster that pulls the first fruit through into the nozzle, wherein the first fruit that has traversed through the conduit is decelerated by the wedge and deflected by the wedge to the first section when the wedge is in the first position. The method also includes detecting, by a controller of the harvesting device, that the first fruit has impacted the wedge. The method further includes, responsively, causing, by the controller of the harvesting device, the wedge to rotate from the first position to the second position, such that the second fruit subsequently pulled from the fruit cluster and that has traversed through the conduit is decelerated by the wedge and deflected by the wedge to the second section.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates a double fruit cluster growing from a spur, in accordance with an example implementation.

FIG. 2A illustrates a perspective view of a harvesting device, in accordance with an example implementation.

FIG. 2B illustrates a perspective cross-sectional view of the harvesting device shown in FIG. 2A, in accordance with an example implementation.

FIG. 3A illustrates a partial cross-sectional frontal view of a harvesting device in a first state, in accordance with an example implementation.

FIG. 3B illustrates a rear view of the harvesting device in the first state, in accordance with an example implementation.

FIG. 4A illustrates a partial cross-sectional frontal view of a harvesting device in a second state, in accordance with an example implementation.

FIG. 4B illustrates a rear view of the harvesting device in the second state, in accordance with an example implementation.

FIG. 5A illustrates a partial perspective view of a harvesting device having bump sensors, in accordance with an example implementation.

FIG. 5B illustrates a partial side view of the harvesting device shown in FIG. 5A, in accordance with an example implementation.

FIG. 6 is a flowchart of a method for operating a harvesting device, in accordance with an example implementation.

### DETAILED DESCRIPTION

Fruit such as apples are typically attached to a tree branch of a tree via a stem. A section where fruit grows from the tree branch can be referred to as a spur. One or more fruits grow from the spur. The spur supports fruit and remains attached to the tree branch after plucking the fruit to support next season's fruit. Damage to the spur may result in fruit not growing from this section of the tree next season.

The stem can further include an abscission further down from the spur. The abscission appears as a bulge and is composed of fibers. As fruit ripens, the fibers of the abscission might no longer be able to hold the weight of fruit, and fruit may thus fall off the tree separated at the abscission. To pluck or harvest fruit without causing damage to the spur, it may be desirable to separate the fruit from the stem at the abscission.

In some cases, during blossoming of fruits, spurs might turn into several flowers, e.g., five flowers. Each of these flowers may grow into its own fruit and thus a cluster of fruits may form. For instance, if five flowers grow from a spur, then five fruits may grow from the spur. If all flowers are left to grow, nutrition or energy going into one spur of the tree is used to feed multiple growing fruits. As a consequence, the resulting fruits may grow to be small and might not have high value to farmers.

As such, farmers may remove some of the flowers chemically, manually, or mechanically, and leave one, two, and in some cases, although not common, three flowers. If one flower is left, one large fruit may result, and if two flowers are left, two medium size fruits may result. In some cases, allowing two flowers to grow to produce a double fruit cluster is valuable economically than allowing fewer or more flowers.

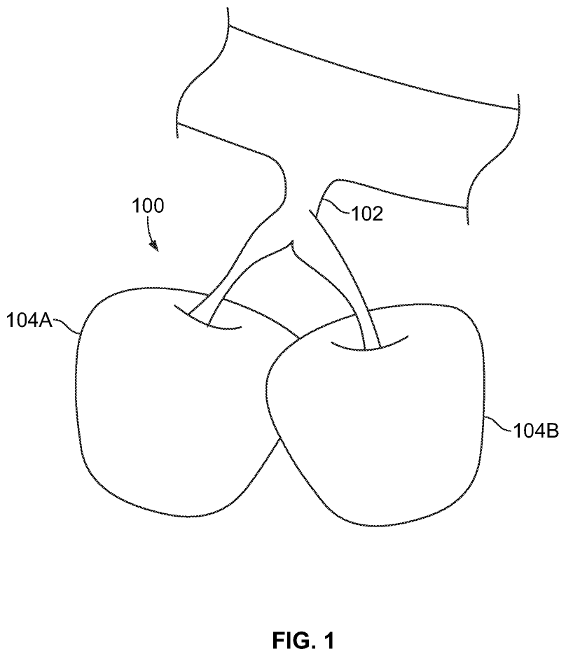

FIG. 1 illustrates a double fruit cluster 100 growing from a spur 102, in accordance with an example implementation. As shown in FIG. 1, two fruits 104A, 104B are connected by respective stems to the spur 102. If a first fruit (e.g., the fruit 104A) of the double fruit cluster 100 is plucked, the second fruit (e.g., the fruit 104B) is likely to fall to the ground shortly thereafter if not plucked simultaneously with, or within a short period of time (e.g., less than a 100 millisecond) from plucking, the first fruit. A falling fruit is likely to get damaged and might not have economic value.

Therefore, it may be desirable to have a robotic harvesting system with an end-effector configured to pluck multiple fruits substantially simultaneously or within a short period of time (e.g., less than 100 millisecond) from each other. Further, it may be desirable to have an end-effector that can separate a first fruit from a second fruit to reduce the chance of collision or impact between two fruits that can bruise or damage them. Disclosed herein are example implementations of an end-effector configured to be coupled to a robotic arm of a robotic harvesting system and configured to pluck multiple fruits substantially simultaneously, while reducing the chance of impact between the plucked fruits.

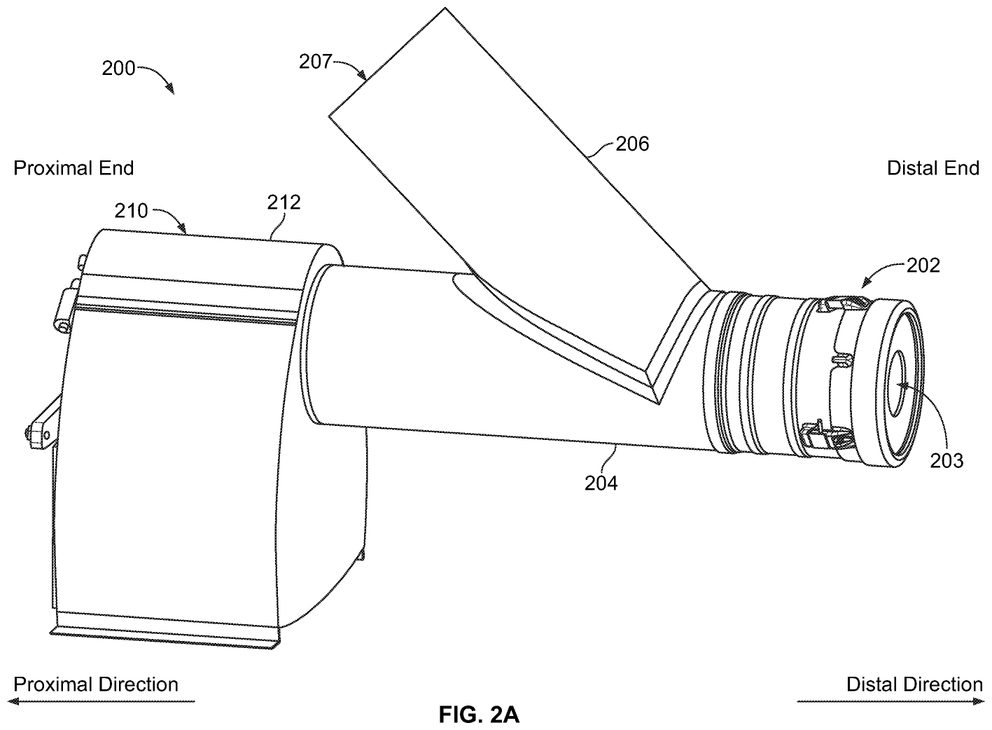

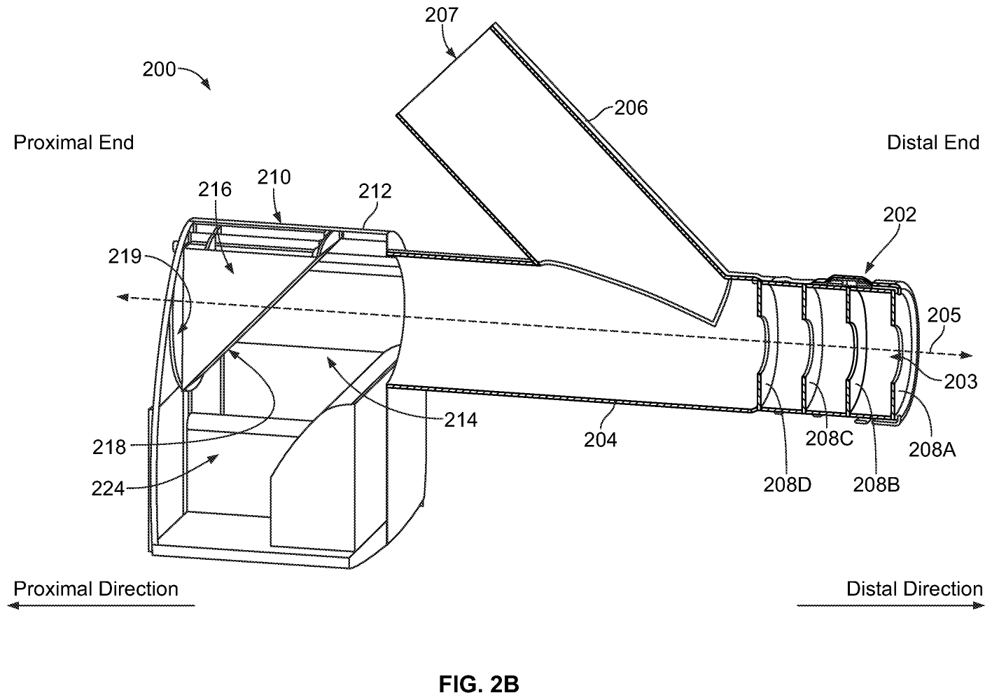

FIG. 2A illustrates a perspective view of a harvesting device 200, and FIG. 2B illustrates a perspective cross-sectional view of the harvesting device 200, in accordance with an example implementation. The harvesting device 200 may also be referred to as an end-effector that can be coupled to a robotic arm of a robotic harvesting system.

The harvesting device 200 includes a nozzle 202 having an inlet 203. The inlet 203 of the nozzle 202 has a size that allows fruit of a particular type to pass through the inlet 203 and enter the nozzle 202. In operation, a vision sensor, such as a camera, coupled to the harvesting device 200 may be used to provide image data to a controller of the robotic harvesting system. Based on the image data, the controller can identify a double fruit cluster such as the double fruit cluster 100. The controller can accordingly command the robot arm to which the harvesting device 200 is coupled to position the harvesting device 200 such that the nozzle 202 is within a predetermined distance from the cluster (e.g., within 1-5 centimeters from the cluster).

The harvesting device 200 includes a first conduit 204 and a second conduit 206. The second conduit 206 is mechanically and fluidly coupled to the first conduit 204. As shown in FIGS. 2A-2B, in examples, the first conduit 204 can be straight, whereas the second conduit 206 can be angled relative to longitudinal axis 205 of the first conduit 204. The nozzle 202 can be coupled to a distal end of the first conduit 204 or can be an integral part of the first conduit 204.

A vacuum generating device (not shown) can be configured to generate a vacuum environment within the harvesting device 200 (e.g., within the second conduit 206 and the first conduit 204). For instance, a blower not shown in FIGS. 2A-2B can be fluidly coupled to the harvesting device at port 207 or proximal end of the second conduit 206 to generate a vacuum environment in the second conduit 206. The vacuum environment extends into the first conduit 204, because the first conduit 204 is fluidly coupled to the second conduit 206. The vacuum environment within the first conduit 204 causes a suction force to be applied to fruit disposed near the distal end of the nozzle 202. The suction force can cause fruit to be plucked and drawn through the inlet 203 of the nozzle 202 to within the nozzle 202. In other example implementations, the harvesting device 200 can include a single conduit (e.g., the first conduit 204) and the vacuum generating device can be coupled directly to the first conduit 204.

As shown in FIG. 2B, the nozzle 202 includes a series of baffles 208A, 208B, 208C, and 208D. Each of the baffles 208A-208D is disposed within the nozzle 202 and is formed as a doughnut- or ring-shaped baffle or plate that has a hole to allow a plucked fruit to go through. The baffles 208A-208D can be thin and are made of an elastic, compliant material.

The series of baffles 208A-208D can be configured to compensate for the difference in sizes of fruits such that the fruits are accelerated to substantially the same speed regardless of their sizes. The holes in the baffles 208A-208D can be large enough to accommodate the size of a small fruit. As such, a small fruit is likely to pass through the holes in the baffles 208A-208D substantially without drag as they pass through respective holes of the baffles 208A-208D with little or no interaction between the fruit and the baffles 208A-208D. At the same time, the baffles 208A-208D form a sealing surface about the fruit to maintain the level of suction force applied to the fruit via the vacuum environment generated within the harvesting device 200. As a result, the small fruit is accelerated to a particular speed without hindrance.

When a larger fruit is plucked, the fruit passing through the holes of the baffles 208A-208D can cause the baffles 208A-208D to deform as the baffles 208A-208D are made of a soft, elastic, compliant material. Due to the elasticity of the baffles 208A-208D, they deform to a degree sufficient to allow the fruit to pass with minimal interaction or contact, and thus with minimal drag. At the same time, the baffles 208A-208D form a sealing surface about the fruit to minimize the drag. As such, the baffles 208A-208D form a seal around the fruit without a drag effect that slows the fruit down. With this configuration, larger fruits are not slowed down as much as they would be without the baffles 208A-208D. By having the fruit passing through a particular number of baffles (e.g., four as shown in FIG. 2B), all fruits regardless of their size are accelerated to substantially the same speed.

The suction force applied to the fruit accelerates the fruit as it is drawn within the first conduit 204. Momentum of the fruit due to the suction force applied thereto causes the fruit to travel along the first conduit 204 toward the proximal end of the first conduit 204.

The harvesting device 200 further includes a deceleration structure 210 disposed at the proximal end of the first conduit 204. The deceleration structure 210 includes a housing 212 coupled to the proximal end of the first conduit 204. The housing 212 includes or defines therein a chamber 214 configured to receive the fruit from the first conduit 204.

Further, the deceleration structure 210 includes a block or wedge 216 disposed at proximal end of the housing 212 in a travel path of fruit that has travelled through the first conduit 204 and received within or at the chamber 214 (e.g., a travel path along the longitudinal axis 205). Due to the momentum of the fruit, the fruit impacts the wedge 216. The wedge 216 can, for example, be made of a thick piece of foam or a similar elastic material configured to absorb kinetic energy of a fruit to decelerate the fruit without causing damage thereto.

The wedge 216 has an angled surface 218 that is configured to direct or deflect the fruit to a bottom portion of the chamber 214 upon impact between the fruit and the wedge 216. In an example, the wedge 216 can be configured as shown in FIG. 2B as a triangular prism having the angled surface 218 facing the proximal end of the first conduit 204. The angled surface 218 is thus disposed in the travel path of the fruit to interact with the fruit upon impact, absorb its kinetic energy of the fruit, and direct it to the bottom portion of the chamber 214.

As mentioned above, the harvesting device 200 can be positioned near a double fruit cluster such as the double fruit cluster 100 and can be configured to pluck a first fruit of the cluster and then within a short period of time (e.g., 100 millisecond) pluck a second fruit of the cluster. It may be desirable to accelerate the fruits to a high speed to avoid collision between two consecutively plucked fruits of a cluster of fruits. In particular, two fruits plucked consecutively could collide if a short period of time separates plucking of the first fruit from plucking the subsequent fruit. However, if the first plucked fruit is accelerated to a high speed, a large distance or space may separate the first fruit from a subsequent fruit, thus avoiding collision therebetween.

Further, it may be desirable to separate the two fruits when they are directed by the wedge 216 to the bottom portion of the chamber 214. By separating the fruits and avoiding collision therebetween as they are directed to the bottom portion of the chamber 214, damage and bruising of the fruits can be prevented. The harvesting device 200 is configured to direct or distribute the fruits to two different sections of the chamber 214 that are separated by a partition so as to reduce the chance of the two fruits bumping into each other.

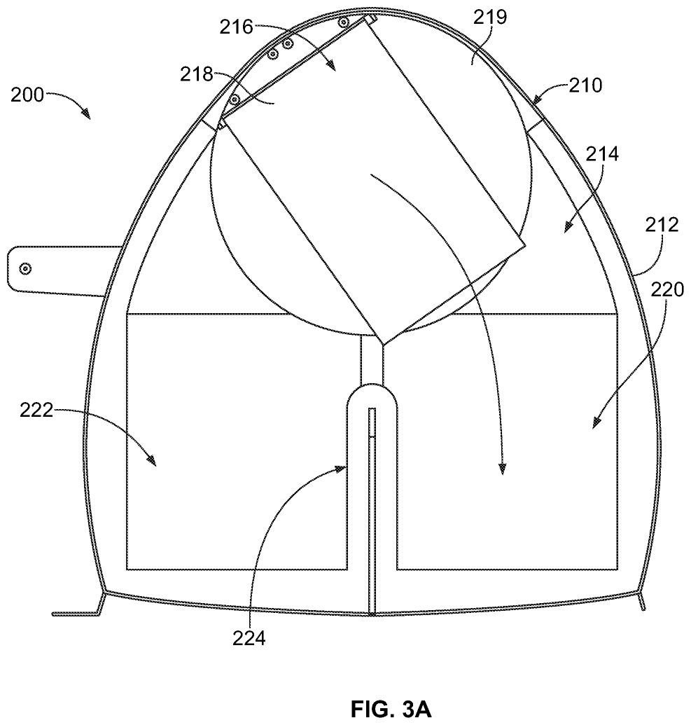

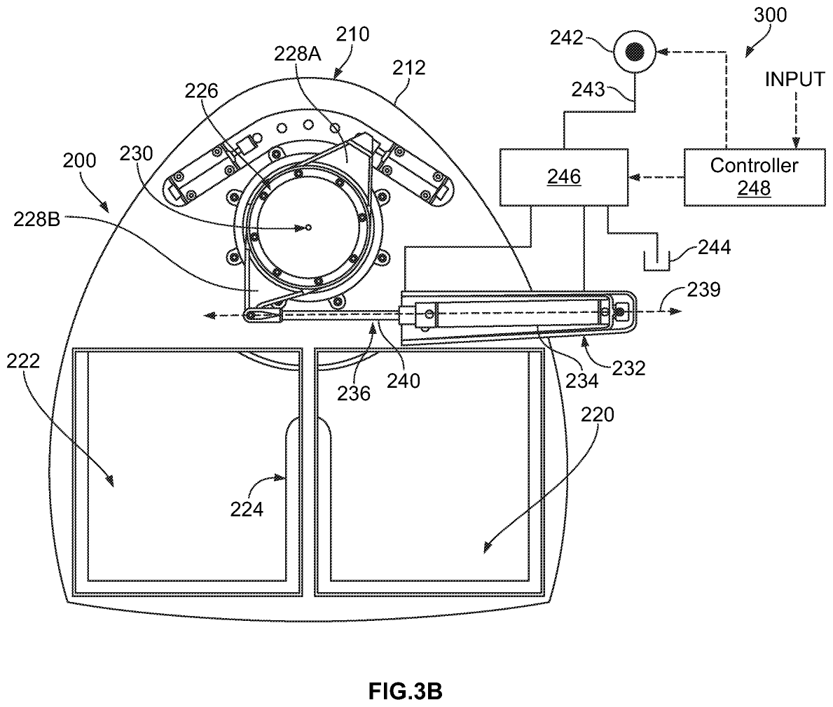

FIG. 3A illustrates a partial cross-sectional frontal view of the harvesting device 200 in a first state, and FIG. 3B illustrates a rear view of the harvesting device 200 in the first state, in accordance with an example implementation. FIG. 3B depicts a harvesting system 300 that includes the harvesting device 200. The harvesting system 300 can be part of or comprised within a larger robotic harvesting system having a robotic arm coupled to the harvesting device 200 and configured to move the harvesting device 200.

The wedge 216 is configured to be rotatably mounted within the housing 212. For example, as shown in FIG. 3A, the wedge 216 can be coupled or mounted to a rotatable disk 219 disposed in an inner surface of the housing 212 at the proximal end of the housing 212. The rotatable disk 219 can be rotatable about the longitudinal axis 205 of the first conduit 204. Further, the bottom portion of the chamber 214 is divided into a first section 220 and a second section 222 by a divider 224.

Referring now to FIG. 3B, the rotatable disk 219 can be coupled to a bracket 226. For instance, the bracket 226 can be attached to the rotatable disk 219 via a plurality of fasteners. The bracket 226 has two protrusions 228A, 228B extending radially outward from a center point 230 of the bracket 226, which can also be a center point of the rotatable disk 219.

The harvesting device 200 further includes an actuator 232. The actuator 232 is depicted as a pneumatic or hydraulic actuator having a cylinder 234 and a piston 236. The piston 236 can include a piston head disposed within the cylinder 234 and a rod 240 extending from the piston head along a longitudinal axis 239 of the cylinder 234. The piston head divides inner space of the cylinder 234 into a first chamber and a second chamber.

Further, the rod 240 is coupled to the protrusion 228B of the bracket 226. With this configuration, the rod 240, which is disposed along the longitudinal axis 239, is coupled to a point in the protrusion 228B that is offset from the center point 230 of the bracket 226 and the rotatable disk 219. With this configuration, longitudinal motion of the rod 240 of the piston 236 applies a moment on the bracket 226 about the center point 230, thereby causing the bracket 226, the rotatable disk 219 coupled to the bracket 226, and the wedge 216 attached to the rotatable disk 219 to rotate about the longitudinal axis 205 of the first conduit 204.

The harvesting system 300 can also include a source 242 of fluid. The term “fluid” is used herein as including any gas or liquid. For instance, the fluid can be air or hydraulic oil. The source 242 of fluid can, for example, be a pump or compressor configured to receive fluid from a reservoir or tank 244, pressurize the fluid, and then provides the pressurized fluid through a supply line 243. Additionally or alternatively, the source 242 of fluid can be an accumulator.

The harvesting system 300 can further include a valve assembly 246 that is fluidly coupled to the source 242, the actuator 232, and the tank 244. As such, the valve assembly 246 can be configured to control fluid flow between the source 242, the actuator 232, and the tank 244. As an example for illustration, the valve assembly 246 can include a four-way, directional-control valve configured to control the direction of fluid flow to and from the actuator 232 to control the direction of movement of the piston 236. The valve assembly 246 can, for example, be actuatable via an actuation mechanism such as a solenoid actuator, a pneumatic or hydraulic pilot fluid actuator, or a manual actuator.

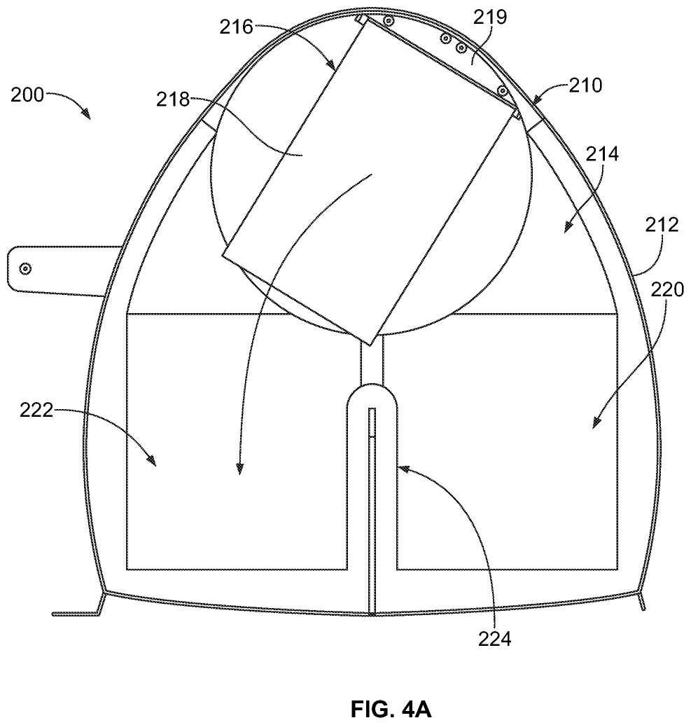

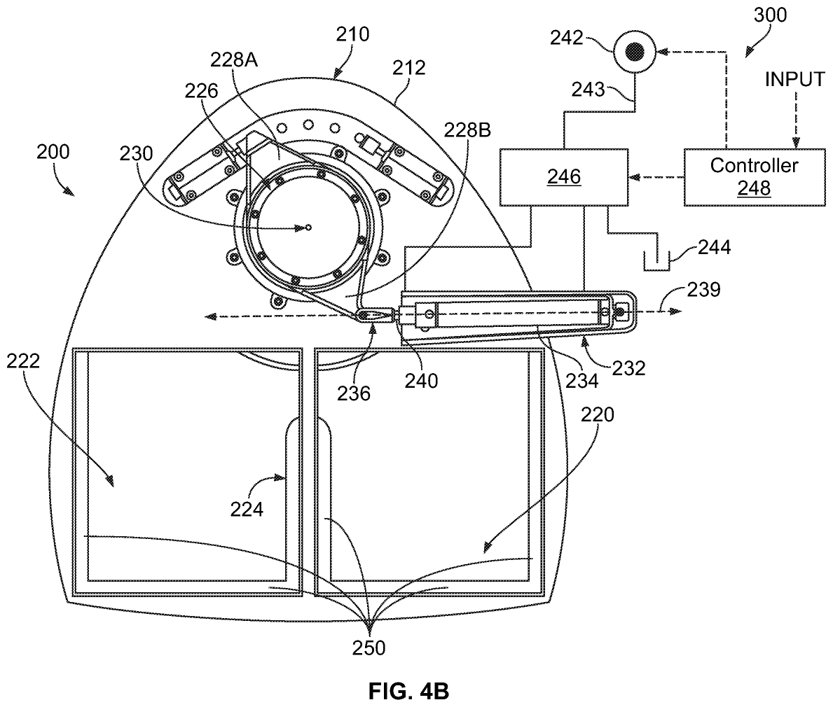

The valve assembly 246 can be switched between at least a first state and a second state. In the first state, the valve assembly 246 can allow fluid flow from the source 242 to the first chamber of the cylinder 234, while fluidly coupling the second chamber of the cylinder 234 to the tank 244. As a result, the piston 236 can extend to the position depicted in FIG. 3B. In the second state, the valve assembly 246 can allow fluid flow from the source 242 to the second chamber of the cylinder 234, while fluidly coupling the first chamber of the cylinder 234 to the tank 244. As a result, the piston 236 can retract (see FIG. 4B).

The harvesting system 300 can further include a controller 248 configured to operate the harvesting device 200. The controller 248 can include one or more processors or microprocessors and may include data storage (e.g., memory, transitory computer-readable medium, non-transitory computer-readable medium, etc.). The data storage may have stored thereon instructions that, when executed by the one or more processors of the controller 248, cause the controller 248 to perform operations described herein. The controller 248 can be a dedicated controller configured to operate the harvesting system 300, or can be the controller configured to control the robotic harvesting system that includes the harvesting system 300.

Signal lines to and from the controller 248 are depicted as dashed arrows in FIG. 3B, while fluid lines are depicted as solid lines. The controller 248 can receive input such as sensor information via signals from various sensors or input devices in the harvesting system 300, and responsively provide electric signals to various components such as the valve assembly 246 and the source 242.

In operation, the controller 248 can actuate valve assembly 246 so as to extend the piston 236 to the position shown in FIG. 3B. Such extended position of the piston 236 corresponds to the wedge 216 being disposed at a particular angle (as shown in FIG. 3A) relative to the longitudinal axis 205 of the first conduit 204. As such, when a first plucked fruit of a double fruit cluster impacts the wedge 216, the angled surface 218 directs or deflects the fruit to the first section 220.

The controller 248 can receive an input (e.g., sensor information) indicating that the first plucked fruit impacted the wedge 216. For example, a proximity sensor or accelerometer can be coupled to the wedge 216 and can be configured to provide sensor information to the controller 248 indicating that an impact has occurred between the wedge 216 and the first fruit. Alternatively or additionally, the harvesting device 200 can include a motion sensor disposed within the housing 212 or the first conduit 204 proximate to the wedge 216 to detect that a fruit entered the chamber 214 and has impacted the wedge 216. A proximity sensor or other types of sensors configured to detect presence or passing of the fruit to within the chamber 214 can be used. As the sensor is tripped by the presence or passing of the first fruit, the sensor provides information indicative of the presence of the fruit in the chamber 214 to the controller 248, and the controller 248 can then determine that impact has occurred.

In response to the sensor information, the controller 248 can then send a signal to actuate the valve assembly 246 (e.g., send a signal to a solenoid of a valve within the valve assembly 246) to operate in the second state. As a result, the piston 236 retracts.

FIG. 4A illustrates a partial cross-sectional frontal view of the harvesting device 200 in a second state, and FIG. 4B illustrates a rear view of the harvesting device 200 in the second state, in accordance with an example implementation. In response to the controller 248 actuating the valve assembly 246, the piston 236 retracts as shown in FIG. 4B. As the piston 236 retracts, the rod 240, which is coupled to the protrusion 228B, pulls the bracket 226 (e.g., to the right in FIGS. 3A-4B), thereby applying a moment about the center point 230 and causing the bracket 226 and the rotatable disk 219 coupled thereto to rotate.

The rotation of the rotatable disk 219 causes the wedge 216 mounted to the rotatable disk 219 to rotate by a particular angle (e.g., rotate by an angle between 30 and 60 degrees). As a result, the angled surface 218 is now be positioned such that a second or subsequent fruit of the double fruit cluster that has been plucked immediately or shortly after the first fruit can be deflected to the second section 222, as shown in in FIG. 4A. In this way, the second fruit is separated from the first fruit (which has been deflected to the first section 220 as shown in FIG. 3A) so that the two fruits do not bump into each other.

With this configuration, the first and second fruits are separated from each other to reduce the chance of collision therebetween and thereby avoid bruising the fruits. The sections 220, 222 and the divider 224 can be padded by padding layer 250 as indicated in FIG. 4B. The padding layers 250 can be made of, for example, open cell foam or any other similar soft material that absorbs kinetic energy of a falling fruit without bruising the fruit. In examples, the padding layer 250 may be covered with another layer of silicon or urethane or any type of rubber coating to reduce wear. As such, the fruits are decelerated by deflection into their respective sections, as described above. The fruits in the sections 220 and 222 can then be separately dispensed therefrom, for example, as described below.

The harvesting device 200 can further include a dispensing mechanism configured to dispense the fruits from the sections 220, 222 to a distribution system that can then transfer the fruits to another portion of the harvesting system 300 or the robotic harvesting system that includes the harvesting system 300 for further processing or storage. In one example implementation, the harvesting device 200 can include dispensing doors underneath the sections 220, 222, i.e., dispensing doors configured as bottom boundaries of the sections 220, 222. The dispensing doors can be rotatably mounted to respective hinged rails. The rails can be configured to allow the dispensing doors to pivot between a closed position where the fruits are enclosed within the sections 220, 222 and an open position, where the fruits are dispensed from the sections 220, 222.

After dispensing the fruits, the dispensing mechanism can be closed to reseal or reclose the sections 220, 222. The harvesting device 200 is now ready to pick fruits of another cluster. The controller of the robotic harvesting system can detect another double fruit cluster and move the robotic arm coupled to the harvesting device 200 to position the nozzle 202 within a particular distance from the double fruit cluster. A first fruit can be plucked and provided to the second section 222. The controller 248 can then actuate the valve assembly 246 to extend the rod 240 and rotate the bracket 226, the rotatable disk 219, and the wedge 216 back to their initial position so as to deflect a subsequently plucked fruit to the first section 220 to separate the fruits from each other. These steps can be repeated to pluck fruit of different clusters without bruising the fruit, by distributing them to different sections of chamber 214.

The actuation mechanism described above with respect to FIGS. 3A-4B is an example for illustration only, and other actuation mechanism can be used. For instance, an electric motor can be coupled to the rotatable disk 219, such that actuation of the electric motor (e.g., via the controller 248) causes the rotatable disk 219 and the wedge 216 to rotate. In another example, a hydraulic motor can be used. Gear reducers can be used as well to control rotational speed of the rotatable disk 219.

In some cases, it may be desirable to detect that the harvesting device 200 collided with or impacted a tree or tree branch. Upon detecting such impact, controller of the robotic harvesting system that includes the harvesting system 300 can command the harvesting device 200 to retract from the tree or tree branch to avoid damage to the tree. Thus, in addition to any vision sensors, the harvesting device 200 can be configured to have one or more load cells that operate as bump sensors to provide information to the controller 248 indicating that an impact has occurred.

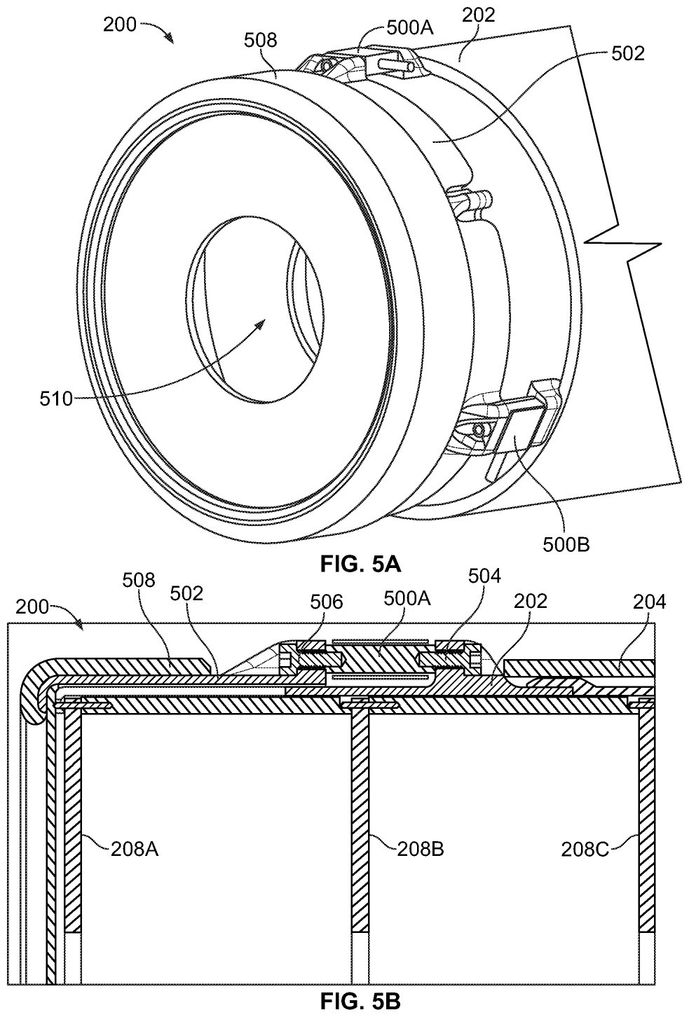

FIG. 5A illustrates a partial perspective view of the harvesting device 200 having bump sensors 500A and 500B, and FIG. 5B illustrates a partial side view of the harvesting device 200, in accordance with an example implementation. The bump sensors 500A, 500B can be configured, for example, as force sensors (e.g., load cells) operable to measure forces applied thereto.

As shown in FIGS. 5A-5B, the harvesting device 200 may have a shroud 502 disposed about a periphery of the nozzle 202. The bump sensors 500A, 500B are disposed between and configured to couple the shroud 502 and the nozzle 202. The bump sensors 500A, 500B are disposed circumferentially spaced apart about the periphery of the shroud 502.

In particular, referring to FIG. 5B, the bump sensor 500A may be coupled to a structure of the nozzle 202 (and thus coupled to the structure of the harvesting device 200) via a fastener 504. The bump sensor 500A is also coupled via a fastener 506 to the shroud 502.

The shroud 502 can be configured to be separated from the nozzle 202 or the structure of the harvesting device 200 by a small “hairline” gap. In other words, the shroud 502 can be configured to “float” relative to the structure (e.g., the nozzle 202) of the harvesting device 200. With this configuration, the nozzle 202 (e.g., the structure of the harvesting device 200) is configured as a “reference” structure for the bump sensor 500A at one end thereof, and the bump sensor 500A can thus measure forces applied to the shroud 502 and transferred to the other end of the bump sensor 500A via the fastener 506. The bump sensor 500B is mounted in a similar manner to the bump sensor 500A and can operate in a similar manner. The bump sensors 500A, 500B are configured to be in communication with the controller of the robotic harvesting system and are configured to provide information thereto indicative of the measured forces.

Although two bump sensors 500A, 500B are shown in FIGS. 5A-5B, more of fewer sensors could be used. For example, a third sensor could be added, and the three bump sensor could be disposed 120 degrees apart about the periphery of the nozzle 202. In another example, a fourth sensor could also be added about the periphery of the nozzle 202, and an angle of 90 degrees could separate the bump sensors from each other. These configurations are examples for illustration only.

In examples, the harvesting device 200 may further include a cover 508 disposed at a nose section or distal end of the harvesting device 200 about a periphery of the shroud 502. The cover 508 can be composed of rubber or other compliant material and can protect the shroud 502 as the harvesting device 200 moves about and bumps into objects. The cover 508 can be ring-shaped to have a hole 510 (e.g., as shown in FIG. 5A) configured to allow plucked fruit to pass therethrough to the baffles 208A-208D disposed in the nozzle 202. This way, operation of the bump sensors 500A, 500B, the shroud 502, and the cover 508 does not interfere with or disrupt the fruit plucking operation of the harvesting device 200.

In operation, as the harvesting device 200 moves toward a tree to align the hole 510 with fruit to be plucked therefrom, the harvesting device 200, and particularly, the distal end (e.g., the nozzle 202) of the harvesting device 200 may bump into a tree or a tree branch. An impact force resulting from the harvesting device 200 bumping into the tree of tree branch is measured by the bump sensors 500A, 500B. Information indicative of the measured impact forces is then communicated to the controller of the robotic harvesting system. In response, the controller may command a robotic arm coupled to the harvesting device 200 to retract the harvesting device 200 away from the tree of tree branch to avoid damaging the tree or tree branch.

In examples, the controller can be configured to sum the forces detected by the bump sensors 500A, 500B (and other bump sensors if the harvesting device 200 includes more bump sensors). If the sum of forces exceeds a threshold force, the controller commands the robotic arm to retract the harvesting device 200. In another example, the controller determines an average force of the forces measured by the bump sensors, e.g., the bump sensors 500A, 500B. If the average force exceeds a threshold force level, the controller commands the robotic arm to retract the harvesting device 200. In another example, if an impact force measured at any of the bump sensors, e.g., the bump sensor 500A or 500B, exceeds a threshold force level, the controller commands the robotic arm to retract the harvesting device 200.

The threshold force level may be set to a particular level such that the controller can differentiate between a rigid structure and a soft structure. For example, by comparing a force level (e.g., sum, average, or individual force measurement at the bump sensors 500A, 500B) to a threshold force level, the controller can determine whether the harvesting device 200 bumped into a rigid structure such as a tree or tree branch or bumped into a soft structure such as tree leaves. While the controller can be configured to command the robotic arm to retract the harvesting device 200 if the harvesting device 200 bumps into a rigid structure (e.g., a tree or branch), the controller might allow the harvesting device 200 to move forward if it bumps into a soft structure (e.g., a leaf).

As shown in FIGS. 5A-5B, the bump sensors 500A, 500B are coupled to the nozzle 202 and are disposed at or near the distal end of the harvesting device 200. In other words, the bump sensors 500A, 500B are disposed near the tip of the harvesting device 200. This configuration can enable the controller of the harvesting device 200 to detect small impact forces and take actions accordingly (e.g., retract the harvesting device 200).

In particular, if the bump sensors are disposed away from the tip of the harvesting device 200, which is likely to bump into objects, the impact forces could be dissipated or absorbed in other structural components of the harvesting device 200, and thus lose magnitude before reaching the bump sensors. As result, the bump sensors might not be able to measure small impact force levels that could be substantially reduced to an undetectable level before reaching the bump sensors. However, with the configuration illustrated in FIGS. 5A-5B, the bump sensors 500A, 500B are beneficially disposed at the tip of the harvesting device 200, and can thus detect small force levels resulting from light impacts between the harvesting device 200 and other objects such as trees or tree branches before such forces lose magnitude. As such, placing the bump sensors 500A, 500B as shown in FIGS. 5A-5B enables detection of low force levels even when the harvesting device 200 is moving with high accelerations.

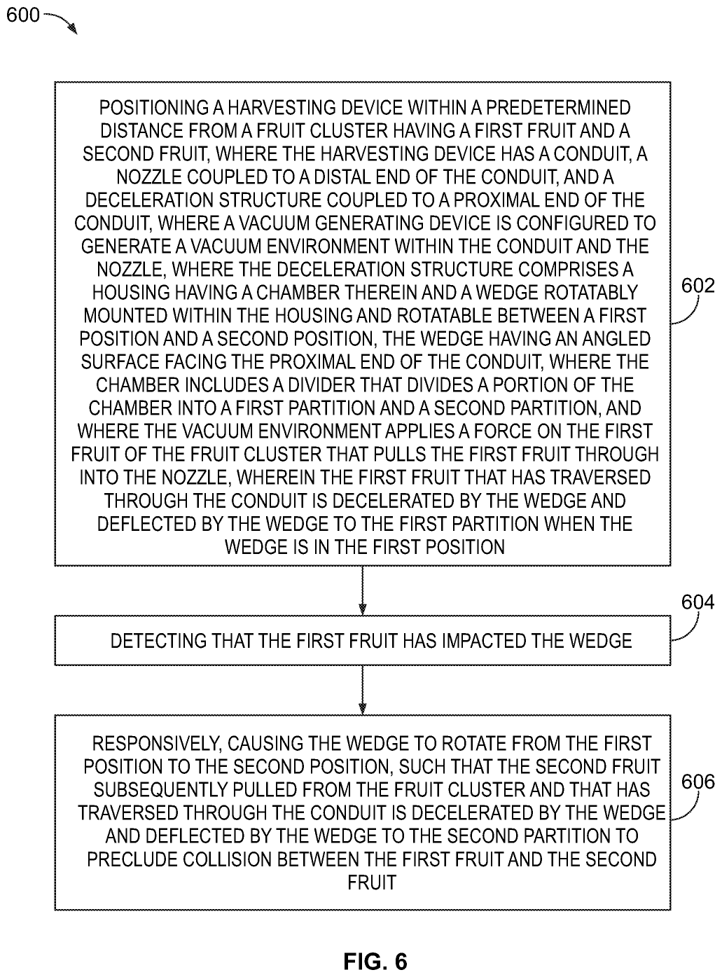

FIG. 6 is a flowchart of a method 600 for operating a harvesting device, in accordance with an example implementation. The method 600 shown in FIG. 6 presents an example of a method that can, for example, be performed by a controller such as the controller 248 to control the harvesting device 200, for example.

The method 600 may include one or more operations, functions, or actions as illustrated by one or more of blocks 602-606. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 600 and other processes and operations disclosed herein, the flowchart shows operation of one possible implementation of present examples. In this regard, each block may represent a module, a segment, or a portion of program code, which includes one or more instructions executable by a processor or a controller for implementing specific logical operations or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the method 600 and other processes and operations disclosed herein, one or more blocks in FIG. 6 may represent circuitry or digital logic that is arranged to perform the specific logical operations in the process.

At block 602, the method 600 includes positioning the harvesting device 200 proximate (e.g., within a predetermined distance from) the double fruit cluster 100 having the first fruit 104A and the second fruit 104B, where the harvesting device 200 has the first conduit 204, the nozzle 202 coupled to a distal end of the first conduit 204, and the deceleration structure 210 coupled to a proximal end of the first conduit 204, where a vacuum generating device is configured to generate a vacuum environment within the first conduit 204 and the nozzle 202 (e.g., via the second conduit 206), where the deceleration structure 210 comprises the housing 212 having the chamber 214 therein and the wedge 216 rotatably mounted within the housing 212 and rotatable between a first position and a second position, the wedge 216 having the angled surface 218 facing the proximal end of the first conduit 204, where the chamber 214 includes the divider 224 that divides a portion of the chamber 214 into the first section 220 and the second section 222, and where the vacuum environment applies a force on the first fruit 104A of the double fruit cluster 100 that pulls the first fruit 104A through into the nozzle 202, wherein the first fruit 104A that has traversed through the first conduit 204 is decelerated by the wedge 216 and deflected by the wedge 216 to the first section 220 when the wedge 216 is in the first position.

At block 604, the method 600 includes detecting that the first fruit 104A has impacted the wedge 216.

At block 606, the method 600 includes, responsively, causing the wedge 216 to rotate from the first position to the second position, such that the second fruit 104B subsequently pulled from the double fruit cluster 100 and that has traversed through the first conduit 204 is decelerated by the wedge 216 and deflected by the wedge 216 to the second section 222. In this way, the chance of a collision between the first fruit 104A and the second fruit 104B can be reduced or precluded.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

What is claimed is:

1. A harvesting device comprising:
a conduit having a distal end and a proximal end;
a nozzle having an inlet, wherein the nozzle is coupled to the distal end of the conduit, wherein a vacuum generating device is configured to generate a vacuum environment in the conduit and the nozzle coupled thereto, and wherein the inlet of the nozzle has a size that allows fruit of a particular type to pass through the inlet and enter the vacuum environment in the nozzle;
a housing coupled to the proximal end of the conduit, wherein the housing defines a chamber therein, and wherein the housing includes a divider that partitions a portion of the chamber into a first section and a second section; and
a wedge rotatably mounted within the housing, wherein the wedge has an angled surface that faces the proximal end of the conduit, wherein the wedge is configured to be rotatable between a first position and a second position, and wherein: (i) when the wedge is in the first position, fruit that has traversed through the conduit is deflected to the first section, and (ii) when the wedge is in the second position, fruit that has traversed through the conduit is deflected to the second section.

2. The harvesting device of claim 1, wherein the wedge is made of a compliant material configured to decelerate fruit upon impact therewith.

3. The harvesting device of claim 1, wherein the conduit is a first conduit, and wherein the harvesting device further comprises:
a second conduit mechanically and fluidly coupled to the first conduit, wherein the second conduit comprises a port configured to be fluidly coupled to the vacuum generating device.

4. The harvesting device of claim 1, further comprising:
a rotatable disk disposed in the housing, wherein the rotatable disk is rotatable about a longitudinal axis of the conduit, and wherein the wedge is attached to the rotatable disk.

5. The harvesting device of claim 4, further comprising:
an actuator coupled to the rotatable disk and configured to rotate the rotatable disk and the wedge attached thereto between the first position and the second position.

6. The harvesting device of claim 5, further comprising:
a bracket coupled to the rotatable disk, wherein the actuator is coupled to the bracket, such that the actuator is configured to rotate the bracket, thereby rotating the rotatable disk coupled thereto and the wedge attached to the rotatable disk.

7. The harvesting device of claim 6, wherein the bracket includes a first protrusion and a second protrusion extending radially outward from a center point of the bracket, and wherein the actuator includes a cylinder and a piston longitudinally movable within the cylinder, wherein the piston has a rod coupled to the second protrusion at a point offset from the center point of the bracket, such that longitudinal motion of the piston within the cylinder applies a moment on the bracket about the center point thereof, thereby causing the bracket and the rotatable disk coupled thereto to rotate.

8. A harvesting system comprising:
a harvesting device comprising:
a conduit having a distal end and a proximal end,
a nozzle coupled to the distal end of the conduit, wherein a vacuum generating device is configured to generate a vacuum environment in the conduit and the nozzle coupled thereto to pull fruit to within the nozzle and cause fruit to traverse the conduit,
a housing coupled to the proximal end of the conduit, wherein the housing defines a chamber therein, and wherein the housing includes a divider that partitions a portion of the chamber into a first section and a second section, and
a wedge rotatably mounted within the housing, wherein the wedge has an angled surface that faces the proximal end of the conduit;
an actuator coupled to the wedge and configured to rotate the wedge about a longitudinal axis of the conduit between a first position and a second position, wherein: (i) when the wedge is in the first position, fruit that has traversed through the conduit is deflected to the first section, and (ii) when the wedge is in the second position, fruit that has traversed through the conduit is deflected to the second section; and
a controller configured to perform operations comprising:
detecting impact of fruit with the wedge, and
responsively, causing the actuator to rotate the wedge.

9. The harvesting system of claim 8, wherein the wedge is made of a compliant material configured to decelerate fruit upon impact therewith.

10. The harvesting system of claim 8, wherein the conduit is a first conduit, and wherein the harvesting device further comprises:
a second conduit mechanically and fluidly coupled to the first conduit, wherein the second conduit comprises a port configured to be fluidly coupled to the vacuum generating device.

11. The harvesting system of claim 8, further comprising:
a rotatable disk disposed in the housing and coupled to the actuator, wherein the rotatable disk is rotatable about the longitudinal axis of the conduit via the actuator, and wherein the wedge is attached to the rotatable disk.

12. The harvesting system of claim 11, wherein the actuator comprises: a cylinder and a piston longitudinally movable within the cylinder, wherein the piston has a rod coupled to the rotatable disk at a point offset from a center point of the rotatable disk, such that longitudinal motion of the piston within the cylinder applies a moment on the rotatable disk about the center point thereof, thereby causing the rotatable disk and the wedge attached thereto to rotate.

13. The harvesting system of claim 12, further comprising:
a source of fluid;
a tank; and
a valve assembly configured to control fluid flow between the source of fluid, the actuator, and the tank, such that when the valve assembly is in a first state, fluid flow through the valve assembly to the actuator causes the piston to extend, thereby causing the wedge to be in the first position, and wherein when the valve assembly is in a second state, fluid flow through the valve assembly to the actuator causes the piston to retract, thereby causing the wedge to be in the second position.

14. The harvesting system of claim 13, wherein causing the actuator to rotate the wedge comprises:
sending a signal to the valve assembly to actuate the valve assembly.

15. The harvesting system of claim 12, further comprising:
a bracket coupled to the rotatable disk, wherein the actuator is coupled to the bracket, such that the actuator is configured to rotate the bracket, thereby rotating the rotatable disk coupled thereto and the wedge attached to the rotatable disk.

16. The harvesting system of claim 15, wherein the bracket comprises a first protrusion and a second protrusion extending radially outward from the center point, and wherein the rod of the actuator is coupled to the second protrusion, such that the longitudinal motion of the piston within the cylinder applies the moment on the bracket about the center point, thereby causing the bracket and the rotatable disk coupled thereto to rotate.

17. The harvesting system of claim 8, wherein the nozzle includes a series of ring-shaped baffles comprising a compliant material.

18. The harvesting system of claim 8, further comprising:
a shroud disposed about a periphery of the nozzle at a distal end of the nozzle; and
at least one force sensor configured to couple the shroud to the nozzle and configured to measure impact forces at the distal end of the nozzle.

19. A method comprising:
positioning a harvesting device within a predetermined distance from a fruit cluster comprising a first fruit and a second fruit, wherein the harvesting device has a conduit, a nozzle coupled to a distal end of the conduit, and a deceleration structure coupled to a proximal end of the conduit, wherein a vacuum generating device is configured to generate a vacuum environment within the conduit and the nozzle, wherein the deceleration structure comprises a housing having a chamber therein and a wedge rotatably mounted within the housing and rotatable between a first position and a second position, wherein the wedge comprises an angled surface facing the proximal end of the conduit, wherein the chamber includes a divider that divides a portion of the chamber into a first section and a second section, and wherein the vacuum environment applies a force on the first fruit of the fruit cluster that pulls the first fruit through into the nozzle, wherein the first fruit that has traversed through the conduit is decelerated by the wedge and deflected by the wedge to the first section when the wedge is in the first position;
detecting, by a controller of the harvesting device, that the first fruit has impacted the wedge; and
responsively, causing, by the controller of the harvesting device, the wedge to rotate from the first position to the second position, such that the second fruit subsequently pulled from the fruit cluster and that has traversed through the conduit is decelerated by the wedge and deflected by the wedge to the second section.

20. The method of claim 19, wherein the harvesting device further comprises an actuator coupled to the wedge and configured to rotate the wedge from the first position to the second position, wherein causing, by the controller, the wedge to rotate comprises causing the actuator to rotate the wedge.
